(19) United States
(12) Patent Application Publication
(10) Pub. No.: US 2011/0027047 A1
(43) Pub. Date: Feb. 3, 2011

(54) SOLID RIVET FOR JOINING COMPOSITE COMPONENT PARTS

(76) Inventor: Peter Vas, Bremen (DE)

Correspondence Address: NIXON & VANDERHYE, PC, 901 NORTH GLEBE ROAD, 11TH FLOOR, ARLINGTON, VA, 22203, US

(21) Appl. No.: 12/736,392

(22) PCT Filed: Feb. 25, 2009
(86) PCT No.: PCT/EP2009/052215

§ 371 Date: Oct. 14, 2010

(30) Foreign Application Priority Data
Apr. 4, 2008 (DE) 102008017650.8

(51) Int. Cl. F16B 19/06

(52) U.S. Cl. 411/504

(57) ABSTRACT

The invention relates to a solid rivet having a die head (5) and a shaft (6) which is aligned axially with the die head (5) wherein the maximum diameter of the die head is larger than the outer diameter of the shaft (6).

In order to enable a solid and reliable connection even of FRP component parts with one another without this signifying increased manufacturing expense it is proposed according to the invention that the shaft (6) has at least one end section (11), an intermediate section (10) and a head section (9) wherein the outer diameter of the intermediate section (10) is smaller than the outer diameter of the end section (11).

The invention relates to a solid rivet and more particularly but not exclusively to a solid rivet for joining composite component parts according to the preamble of claim 1.

Solid rivets have been used in large numbers in aircraft construction since the beginning of air travel. Even modern aircraft such as the A380 are assembled with these elements and particularly when assembling the shell the solid rivet is widely used owing to the low costs and ease of automation.

The majority of the solid rivets used at the present time consists of aluminium alloys (2017-T42, 2117-T42 and 7050-T73), but for special cases solid rivets of titanium or titanium alloys are used. Solid rivets of steel are no longer used in aircraft construction. Furthermore there are bi-metal rivets, e.g. from the Cherry company. This rivet consists of a shaft of high-tensile titanium alloy (Ti6A14V) and a shaft end of a soft titanium alloy (Ti45Nb). Both components are connected by friction welding during the manufacture of the rivet.

The installation of the rivet is carried out by reshaping the soft shaft end. In certain marginal conditions these connecting elements are also suitable for joining component parts of fibre-reinforced plastics (FRP) in order to form FRP/FRP structures. For reasons of corrosion it is not possible to use solid rivets made of aluminium and instead a titanium alloy (TiNb45) is used as the rivet material.

The problem with the conventional rivets is that when deforming a rivet large forces occur which lead to the material of the rivet being forced radially outwards in the bore. The material which is forced outwards can damage the material of the joined component particularly at the edges of the bore for the rivet. Whilst in the case of joined components made of metal this leads to a deformation of the metal through which the stability and suitability of the component part is impaired even if only slightly, in the case of FRP components, as a result of the very high pressures which occur when installing the rivet it leads to a delamination of the individual FRP layers in the area of the closing head. In addition to the delamination of laminate layers cracks can also appear in the FRP component.

In order to avoid delamination and the formation of cracks a metal material is therefore necessary on the part of the closing head. This requirement can be met by joining the FRP/FRP structures using metal washers which does mean a high manufacturing expense however.

With the present prior art the joining of FRP/FRP structures by means of solid rivets is thus not possible.

From U.S. Pat. No. 2,358,728 an anchor rivet is known in which a shaft comprises a stepped head, a pin of smaller diameter adjoining the shaft, a groove running transversely to the shaft immediately adjacent the pin, as well as an extra slot for taking up the material.

From U.S. Pat. No. 3,634,928 a method for manufacturing a rivet connection is known in which a rivet is used with has one or more annular grooves in the shaft of the rivet. The groove serves to delay the transition of the rivet into a mushroom shape and the middle section of the rivet is thereby shortened so that the material is forced substantially uniformly outwards.

The object of the present invention is to provide a rivet with which the said drawbacks can be overcome and which enables a solid and reliable connection even of FRP component parts together without involving increased manufacturing expense.

This is achieved through the solid rivet according to claim 1. Preferred embodiments of the invention are the subject of the dependent claims.

One important aspect of the invention is that in the solid rivet according to the prior art there is a recess, groove or chamfer in the shaft of the solid rivet which is located level with the back of the material on the closing head side. Whereas during installation of a classic solid rivet without any such recess or chamfer the FRP component part delaminates starting from the edge of the bore, the chamfer in the case of the solid rivet according to the invention prevents contact of the rivet at the edge of the bore with the component part which is to be joined so that delamination of the FRP component part in this area is prevented.

The solid rivet according to the invention has a die head and a shaft which is aligned axially with the die head wherein the maximum diameter of the die head is greater than the external diameter of the shaft, is characterised in that the shaft has at least one end section, one intermediate section and one head section wherein the outer diameter of the intermediate section is smaller than the outer diameter of the end section.

The solid rivet according to the invention preferably has as one or—if technically possible and expedient—as several features that:

the three sections are each cylindrical;

the end section tapers conically wherein it has a smaller outer diameter at its free end;

the end section is made from a soft material and the intermediate section and/or head section are made from a high-tensile material;

the end section tapers conically wherein it has a smaller outer diameter at its free end;

the transition between the head section and the intermediate section and/or between the intermediate section and the end section is stepped;

the transition between the head section and the intermediate section and/or between the intermediate section and the end section has only one edge;

the difference between the diameters of the head section and of the intermediate section is dependent on the length of the intermediate section;

the first end section is adjoined by a second intermediate section and a second end section.

The rivet according to the invention offers inter alia the following advantages: It is installed exactly like the “classic” rivet, i.e. the known tools can be used and the joining of component parts with the solid rivet according to the invention can take place exactly the same as with the prior art. Furthermore a correspondingly deep chamfer or groove enables weight savings.

Further features and advantages are apparent from the following description of preferred embodiments of the invention in which reference is made to the accompanying drawings.

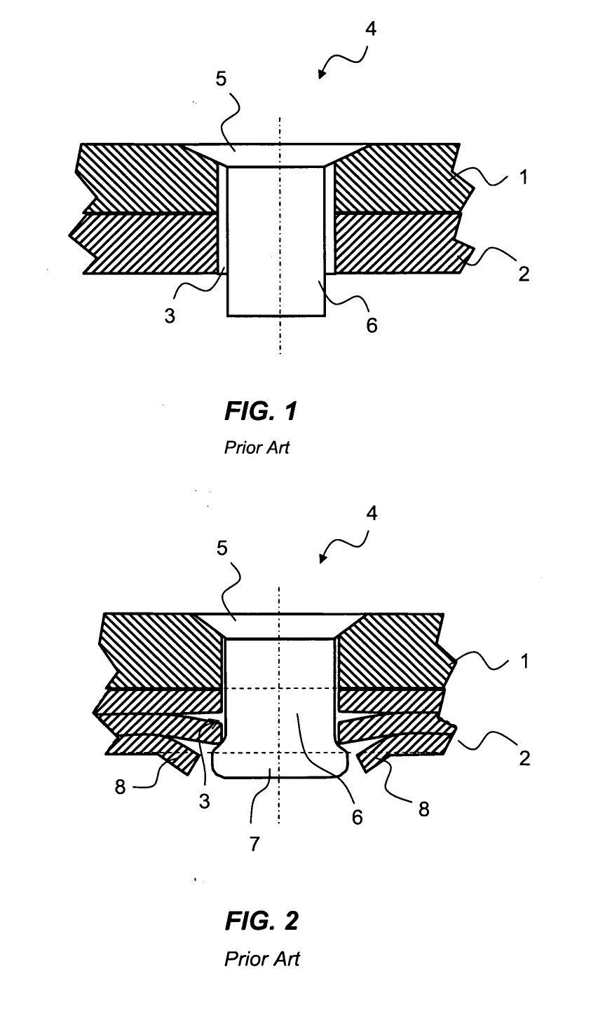

FIG. 1 shows a solid rivet according to the prior art prior to deformation;

FIG. 2 shows the solid rivet according to FIG. 1 after deformation;

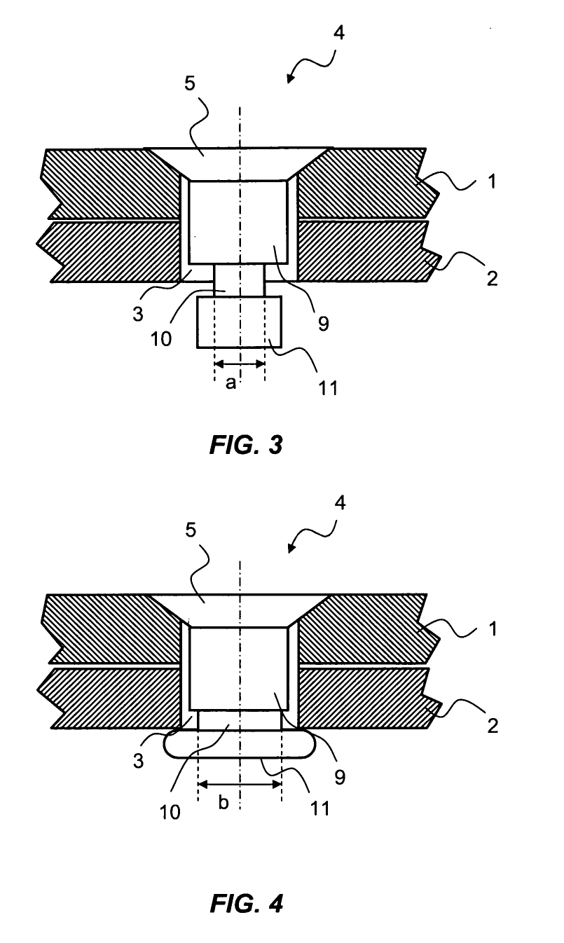

FIG. 3 shows an embodiment of the solid rivet according to the invention prior to deformation;

FIG. 4 shows the solid rivet according to FIG. 3 after deformation;

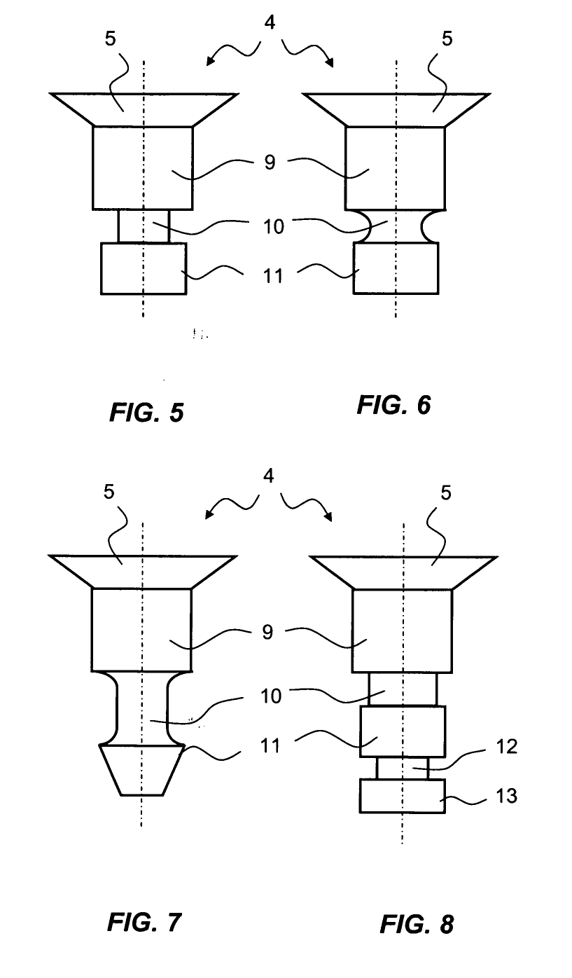

FIGS. 5 to 8 show further preferred embodiments of the solid rivet according to the invention.

The drawing is not true to scale. The same and similar acting elements are provided with the same reference numerals unless otherwise stated.

FIG. 1 shows a solid rivet according to the prior art with which an upper component part 1 and a lower component part 2 are to be connected together, of each of which only a section is shown. For joining the component parts 1 and 2 together a bore 3 is provided which extends through both parts. A solid rivet 4 is pushed through this bore 3 whereby it is prevented on one side by a die head 5 from slipping right through the bore 3. The die head 5 of the solid rivet 4 is adjoined by a shaft 6 which is aligned axially with the die head 5 and is so long that it protrudes over the side of the bore 3 opposite the die head 5. The die head can preferably be countersunk in the surface of the upper component part 1 so that it closes flat with the surface of the component part 1. Its maximum diameter is larger than the internal diameter of the bore 3 and larger than the outer diameter of the shaft 6.

FIG. 2 shows the rivet 4 after joining, i.e. after its reshaping. As can be seen there has been no change to the shape of the die head 5 whilst the free end of the shaft 6 was widened out by the action of a suitable tool so that the outer diameter of the deformed shaft 6 at this point is now larger than the inner diameter of the bore 3. The deformed section of the shaft 6 thus forms a closing head 7 which prevents movement of the solid rivet 4 in the direction of the die head 5 and thereby holds the two component parts 1 and 2 against one another.

As can likewise be seen from FIG. 2 reshaping of the shaft 6 at its free end into the closing head 7 results in damage to the component part 2. Through the pressure action of the material of the rivet 4 which is displaced and compacted during its reshaping the material of the component part 2 is also displaced so that in the area of the outlet edge of the bore 3 individual laminate layers 8 of the component part 2 separate from one another and delaminate. The strength of the laminate structure of the component part 2 is thereby impaired. Furthermore it can also lead to a depression of the component part 2 in the surroundings of the bore 3, as indicated by the dotted lines in FIG. 2 which show the original thickness of the component part and its ideal position after joining.

In order to avoid this undesired deformation of the component part 2 in the vicinity of the bore 3 through the escaping material of the solid rivet 4, the solid rivet 4 according to the invention is provided with a chamfer or groove level with the outlet edge of the bore 3. A first embodiment of a solid rivet of this type according to the invention is shown in FIG. 3.

With the solid rivet 4 according to FIG. 3 the uniform shaft 6 is replaced by three different sections. As a first section the die head 5 is adjoined by a head section 9. This is followed in the direction of the free end of the solid rivet by an intermediate section 10, and this is followed in turn by an end section 11 which forms the free end of the solid rivet 4. The individual sections are characterised or differ from one another in that they all have a diameter which is different from each adjoining section. In particular the outer diameter of the intermediate section 10 is smaller than the outer diameter of the end section 11. Furthermore the outer diameter of the intermediate section 10 is smaller than the outer diameter of the head section 9. The relationship between the diameters of the head section 9 and end section 11 is freely selectable. Thus the head section 9 can have a larger diameter than the end section 11, as shown in FIG. 3, although it is however equally possible to make the diameter of the end section 11 the same size as or slightly larger than that of the head section 9 (not shown). The diameter of the intermediate section 10 is marked in FIG. 3 by “a”.

After the solid rivet 4 has been positioned in the bore 3 as shown in FIG. 3 it is reshaped as in the prior art so that it connects the two component parts 1 and 2 fixedly together. The configuration of the solid rivet 4 after reshaping is shown in FIG. 4.

It is clear from FIG. 4 that after the reshaping of the solid rivet the end section 11 was compressed in the axial direction so that its length was reduced and at the same time its outer diameter became equally as much greater so that it is no longer possible for the reshaped end section 11 to slip through the bore 3. Through the reshaping process the intermediate section 10 was also deformed which directly adjoins the end section 11. In the illustration in FIG. 4 the reshaping of the solid rivet 4 in the case of the intermediate section 10 has led to an enlargement of the diameter from “a” to “b”. This behaviour thus corresponds precisely to that of solid rivets in the case of the prior art, with the difference however that the material is not sufficient to extend the outer diameter “a” of the intermediate section 10 to the inner diameter of the bore 3. And thus the undesired displacement of material of the component part 2 is also avoided which can lead otherwise to delamination of the individual laminate layers 8 according to FIG. 2.

Since the work used during reshaping leads to deformation of the end section 11 as well as of the intermediate section 10 which forms a weak spot in the solid rivet 4, deformation of the head section 9 is avoided, i.e. the bore 3 is not impaired even in the lower lying areas.

The three sections 9, 10 and 11 are each shown cylindrical in FIGS. 3 and FIG. 4. This is however not a condition for the solid rivet according to the invention. Thus the intermediate section 10 can in a further embodiment (not shown) have only in some areas a smaller diameter than its adjoining sections 9 and 11. In this case its cross-sectional shape would thus not be circular in the direction of the axis of symmetry shown in dotted lines in FIGS. 1 to 4, but would be by way of example ellipse-shaped or rectangular with rounded corers or would be a circle with two opposite flattened sides.

Further modifications of the solid rivet according to the invention are shown in FIGS. 5 to 8. In FIG. 5 the embodiment according to FIG. 3 is shown again. The feature of the solid rivet which varies in FIGS. 5 and 6 is the transition between the individual sections. In FIG. 5 the transition between the sections is stepped, i.e. there are two edges between the intermediate section 10 and the head section 9 and between the intermediate section 10 and end section 11 respectively. The embodiment according to FIG. 6 differ from the embodiment according to FIG. 5 in that the transition between the head section 9 and the intermediate section 10 as well as between the intermediate section 10 and the end section 11 is rounded so that each transition only has one edge each. This embodiment is easier to create from the technical production viewpoint since here a groove need be made with only a simple tool whilst with the embodiment according to FIG. 5 the diameter of the intermediate section 10 has to be reduced by milling. Forming the chamfer can thus be carried out by stock-removing work (e.g. by turning) or can be undertaken by reshaping. Both processes can be carried out at the rivet manufacturers or however also at the rivet users.

A further embodiment of the solid rivet according to the invention is shown in FIG. 7. In this embodiment the end section 11 tapers conically wherein it has a smaller outer diameter at its free end. It is thus easier to handle when being set in the bore 3. Furthermore the embodiment of the solid rivet 4 according to FIG. 7 differs from the preceding embodiments in that its intermediate section 10 is extended. The choice of dimensions for the intermediate section 10 (and also the other sections) in the axial direction depends essentially on the strength demands placed on the relevant section and with the diameter “a” of the intermediate section 10.

Finally in FIG. 8 an embodiment is shown which has several intermediate sections and end sections: in addition to the first intermediate section 10 there is a second intermediate section 12 which adjoins the first end section 11. This embodiment is completed by a second end section 13. This embodiment is particularly suitable when component parts 1 and 2 of different thickness are to be joined together by one rivet, but on the other hand different rivets are not to be kept in store.

Apart from the geometrical dimensions of the individual sections 9, 10, 11 the relevant materials can also be selected so that they are best suited for the relevant use of the solid rivet 4. Thus the solid rivet need not be made monolithically from one material but by way of example the end section 11 can be made from a soft material and the intermediate section 10 and the head section 9 respectively can be made from a highly tensile material. In this way it is reached that the end section 11 undergoes the largest part of the deformation work and is reduced in length with a simultaneous increase in its width. Examples for materials are the high tensile Ti6A14V and the softer Ti45Nb.

### REFERENCE NUMERALS

1 Component part top

2 Component part bottom

3 Bore, passing through both component parts

4 Solid rivet

5 Die head

6 Shaft

7 Closing head

8 Laminate layer

9 Head section

10 (first) Intermediate section

11 (first) End section

12 Second intermediate section

13 Second end section

a Diameter of intermediate section prior to deformation

b Diameter of intermediate section after deformation

1. Solid rivet with a die head and a shaft which is aligned axially with the die head wherein the maximum diameter of the die head is larger than the outer diameter of the shaft wherein the shaft has at least one end section an intermediate section and a head section
wherein the outer diameter (a) of the intermediate section is smaller than the outer diameter of the end section
characterised in that the outer diameter (a) of the intermediate section is selected so that when reshaping the solid rivet the material of the intermediate section does not fill out the interspace between the intermediate section and the bore.

2. Solid rivet according to claim 1 characterised in that the three sections are each cylindrical.

3. Solid rivet according to claim 1 characterised in that the end section tapers conically wherein it has a smaller outer diameter at its free end.

4. Solid rivet according to claim 1 characterised in that the end section is made from a soft material and the intermediate section and/or the head section are made from a high tensile material.

5. Solid rivet according to claim 1 characterised in that the end section tapers conically wherein it has a smaller outer diameter at its free end.

6. Solid rivet according to claim 1 characterised in that the transition between the head section and the intermediate section and/or between the intermediate section and the end section is stepped.

7. Solid rivet according to claim 1 characterised in that the transition between the head section and the intermediate section and/or between the intermediate section and the end section only has one edge.

8. Solid rivet according to claim 1 characterised in that the difference between the diameters of the head section and the intermediate section is dependent on the length of the intermediate section.

9. Solid rivet according to claim 1 characterised in that the first end section is adjoined by a second intermediate section and a second end section.
